(19) United States
(12) Patent Application Publication
(10) Pub. No.: US 2008/0223090 A1
(43) Pub. Date: Sep. 18, 2008

(54) Anti-theft lock structure

(75) Inventor: Fei-Chin Liao, Taipei (TW)

Correspondence Address: Muncy, Geissler, Olds & Lowe, PLLC, P.O. BOX 1364, FAIRFAX, VA, 22038-1364, US

(73) Assignee: INVENTEC CORPORATION

(21) Appl. No.: 11/716,558

(22) Filed: Mar. 12, 2007

(51) Int. Cl. E05B 73/00

(52) U.S. Cl. 70/58

(57) ABSTRACT

An anti-theft lock structure including a base, a frame, and a sensor is provided, which is applicable for a lock tongue of a lock to be inserted in. The frame fixed on one side of the base has a lock hole and a stopping portion, wherein the lock hole is engaged with the lock tongue of the lock, and the lock tongue is inserted into the frame through the lock hole. The sensor is fixed in the base and connected to one side of the stopping portion of the frame, for detecting the displacement of the stopping portion relative to the base when the frame is deformed under an external force, so as to generate a trigger signal.

### BACKGROUND OF THE INVENTION

1. Field of Invention

The present invention relates to an anti-theft device for an electronic product. More particularly, the present invention relates to a dual anti-theft lock structure for a portable electronic device.

2. Related Art

As the information gradually becomes electronic data, electronic products have already become an indispensable part in people's daily life. In order to enable users to obtain information at any time anywhere, various electronic products are designed towards the trend of portability by individuals, so as to develop different types of portable electronic devices. Take the most common notebook computer as an example, and due to the high mobility, the notebook computer brings a quick pace and convenience to the work of the business people, which thus gradually replaces the leading position of desktop computers in the personal computer (PC) market.

However, in order to match with the portability property, the weight and size of a portable electronic device are usually limited. Additionally, due to the high unit price of the portable electronic devices, it is easy to become a target for a thief, especially in some auction, exhibition, or public places. Especially, those rather expensive notebook computers may be stolen or get lost, as long as the user is carelessly paid less attention to the notebook computers. As a result, the user may suffer from the loss of money, and what's more important, the confidential documents stored in the notebook computers may be disclosed.

To prevent the notebook computers from being moved by people other than the user, various safety lock holes are formed in the notebook computers, and a steel cable with a lock head are also provided for locking the notebook computer, so as to confine the notebook computer to the desk or the desk leg via the steel cable, thereby alleviating the risk of being moved by others, being stolen, or getting lost.

As disclosed in U.S. Pat. Publication No. 6,578,394, the anti-theft locking device and the aforementioned steel cable lock are both designs on a lock body. Though the current lock manufacturing technique has enhanced the structural strength and precision of a lock, to reduce the probability for the lock to be unlocked or damaged, if an external force exceeding the structural strength of the case of the notebook computer is applied to pull the lock, the structure of the case of the notebook computer around the lock hole may be damaged, such that the lock lost the safety function, and thus causing the notebook computer to be stolen and causing the disclosure of the confidential stored therein.

### SUMMARY OF THE INVENTION

Though the lock hole, a notebook computer in the prior art can be locked by a lock, the structure around the lock hole may still be damaged, such that the lock lost its security function, which thus causes the notebook computer to be stolen. In view of the above problem, the present invention is directed to an anti-theft lock structure, applicable to various portable electronic devices, in which when the lock structure of a portable electronic device is damaged, a second anti-theft mechanism is actuated, so as to enhance the anti-theft protection of the portable electronic device.

To achieve the above objects, the present invention provides an anti-theft lock structure comprising a base, a frame, and a sensor. The anti-theft lock structure is disposed within a portable electronic device and applicable for a lock tongue of a lock to be inserted in, such that the lock is utilized to prevent the notebook computer from being stolen. The base is a major member of a notebook computer, for bearing the electronic elements in the notebook computer. The frame is fixed on one side of the base, and has a lock hole and a stopping portion, in which the lock hole is engaged with the lock tongue of the lock, and the lock tongue is inserted into the frame through the lock hole. The strength of the structural -stress of the frame is greater than that of a connection portion between the frame and the base. The sensor is fixed in the base and closely connected to one side of the stopping portion of the frame, for detecting the displacement of the stopping portion relative to the base when the frame is deformed under an external force, so as to generate a trigger signal.

The effect of the present invention lies in that, when the anti-theft lock structure is damaged, the sensor generates a trigger signal to actuate a second anti-theft mechanism, i.e., a device such as a sound alarm or a hard disk anti-theft lock, so as to significantly alleviate the risk of being stolen of the portable electronic device, and meanwhile, avoid the disclosure of the confidential data in the storage device after the portable electronic device is stolen, and thereby effectively reducing the loss of an individual and an enterprise due to the portable electronic device being stolen.

The detailed features and advantages of the present invention will be described in detail in the following embodiments. Those skilled in the arts can easily understand and implementation the content of the present invention. Furthermore, the relative objectives and advantages of the present invention are apparent to those skilled in the arts with reference to the content disclosed in the specification, claims, and drawings.

The above description of the content of the present invention and the following illustration of the embodiments are intended to demonstrate and explain the principle of the present invention and to provide further explanations of the claims of the present invention.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below for illustration only, which thus is not limitative of the present invention, and wherein:

FIG. 1 is an exploded stereogram of an anti-theft lock structure applied to a portable electronic device according to the present invention;

FIG. 2 is an exploded stereogram of an anti-theft lock structure disposed within a portable electronic device according to the present invention;

FIG. 3 is a schematic stereogram of a base and a frame in the anti-theft lock structure of the present invention;

FIG. 4 is a schematic stereogram of an anti-theft lock structure disposed within a portable electronic device according to the present invention;

FIG. 5 is a schematic stereogram of the frame being bent and deformed to be damaged relative to the base according to the present invention when the lock of the anti-theft lock structure is pulled by an external force;

FIG. 6 is a schematic stereogram of an anti-theft lock structure applied to a portable electronic device according to the present invention; and

FIG. 7 is a schematic stereogram of an anti-theft lock structure applied to a desktop computer mainframe.

### DETAILED DESCRIPTION OF THE INVENTION

The objectives, structures, features, and functions of the present invention will be illustrated below in detail through the embodiments.

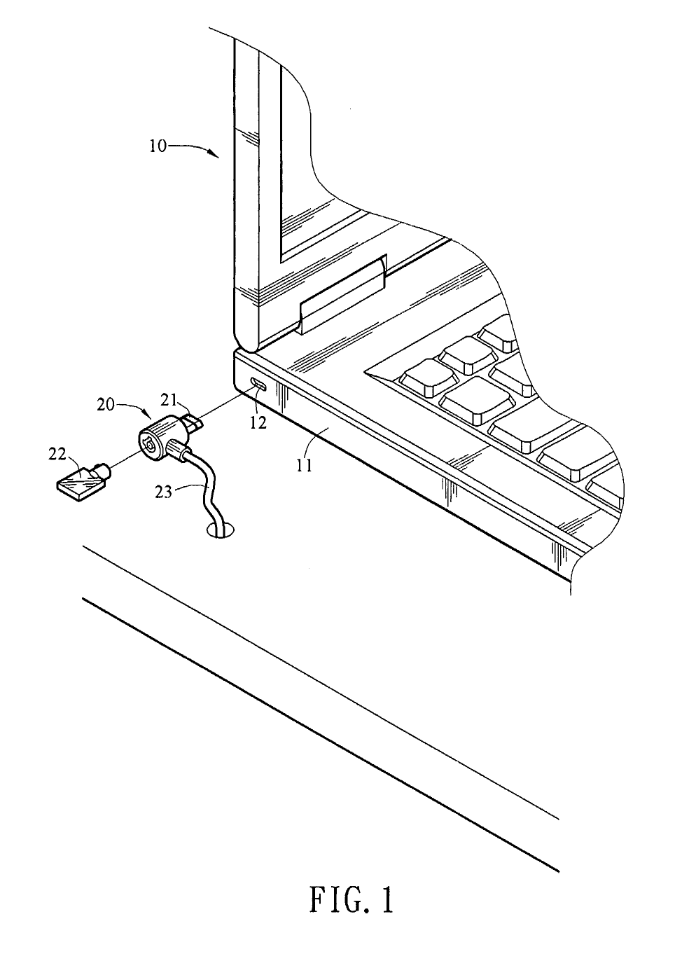

Referring to FIG. 1, it shows a portable electronic device 10 with an anti-theft lock structure according to a first embodiment of the present invention, which can be locked by a lock 20. The portable electronic device 10 can be, but not limited to, notebook computers, personal digital assistants (PDAs), or portable multimedia players.

The portable electronic device 10 has a case 11, for carrying and protecting electronic elements of the portable electronic device 10. An opening 12 is opened in one side of the case 11. A lock tongue 21 is formed at one side of the lock 20 and connected to a lock core (not shown) within the lock 20, such that the lock tongue 21 is rotated upon being driven by the lock core, and thereby being locked at a lock position. The lock tongue 21 is inserted through the opening 12 of the case 11. Once being turned by a key 22, the lock core drives the lock tongue 21 to rotate, such that the front end of the lock tongue 21 cannot be pulled out through the opening 12, thus fixing the lock 20 in the case 11. The lock core is not limited to the lock core of a key lock, but also can be the lock core of a code lock. The other end of the lock 20 is connected to a cable 23, for restricting the lock 20 within a fixed range. For example, the other end of the cable 23 is fixed to a surface of a desk, or wound around a certain object, and thereby restricting the range for moving the portable electronic device 10 through the aforementioned locking manner.

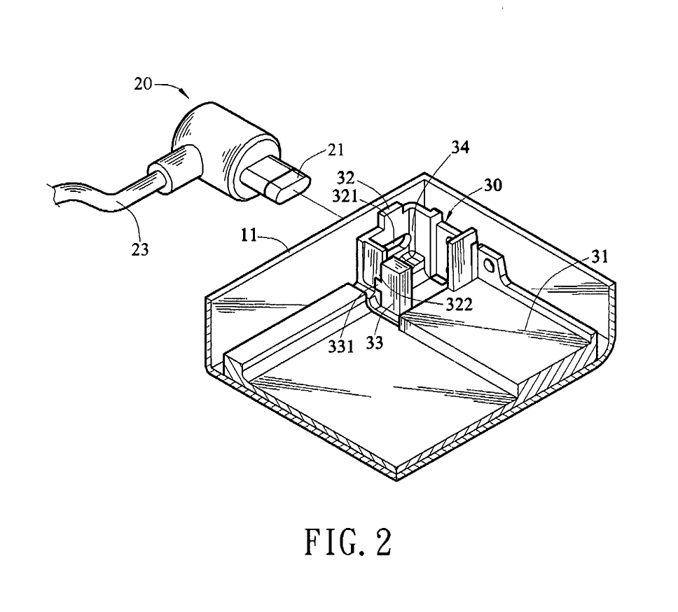

As shown in FIGS. 2, 3, and 4, an anti-theft lock structure 30 according to a first embodiment of the present invention includes a base 31, a frame 32, and a sensor 33. The base 31 is fixed within the case 11 of the portable electronic device 10. The base 31 can be a frame with a high structural strength made of (but not limited to) Al-Mg alloy materials. The frame 32 is fixed at one side edge of the base 31, closely adjacent to one side of the case 11. A lock hole 321 is formed in the frame 32, corresponding to the opening 12 in the case 11, for allowing the lock tongue 21 to pass through the opening 12 and then through the lock hole 321 to reach the inner side of the frame 32. The inner space of the frame 32 and the base 31 form an accommodation space 34, for accommodating the lock tongue 21, and providing the space tolerance for the rotation or movement of the lock tongue 21 when the lock 20 is locked. In addition, after the lock 20 has been locked, the lock tongue 21 cannot be pulled out of the lock hole 321, and thus cannot be released from the frame 32.

The frame 32 protrudes towards the interior of the base 31 to form a stopping portion 322. The sensor 33 is fixed within the base 31, and connected to one side of the stopping portion 322 of the frame 32. When the frame 32 is deformed and even broken under an external force and thus falling off from the base 31, the sensor 33 can detect the displacement of the stopping portion 322 and the frame 32 relative to the base 31, so as to generate a trigger signal. A toggle switch 331 is further disposed on the sensor 33, closely attached to the stopping portion 322, and when the frame 32 is not deformed under a force, the toggle switch 331 is maintained in a normal position due to being tightly pressed by the stopping portion 322. Once the displacement of the frame 32 exceeds a predetermined distance due to being deformed under a force, as the stopping portion 322 generates a displacement relative to the base 31, the toggle switch 331 is released to move to a trigger position, which thus drives the sensor 33 to generate a trigger signal.

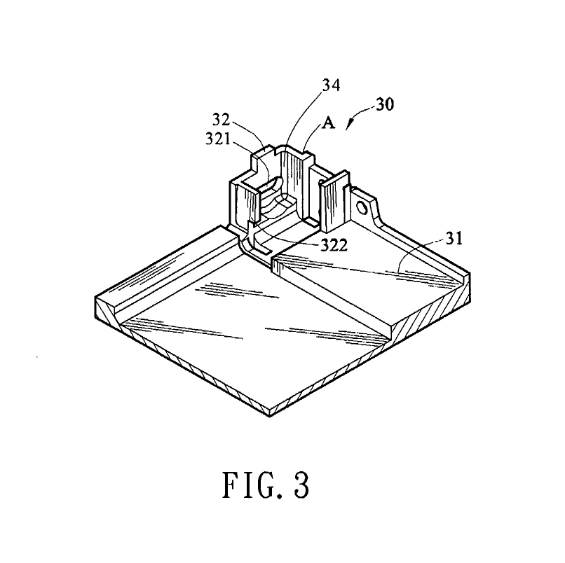

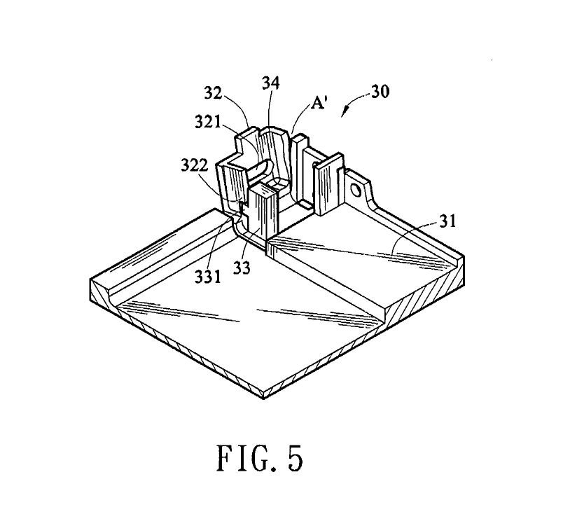

As shown in FIG. 3 and FIG. 5, after the lock 20 has been locked, the lock tongue 21 cannot be pulled out through the opening 12 and the lock hole 321 to be released from the frame 32. If the lock 20 is forced to be pulled out, the lock tongue 21 presses against the wall of the frame 32 around the lock hole 321, thus generating a pulling force to the frame 32 through the lock tongue 21. The overall structural strength of the lock 20 is higher than that of the base 31 and frame 32, such that the lock 20, the lock tongue 21, and the cable 23 may not be damaged upon being pulled by an external force. Although the connection portion between the frame 32 and the base 31 can be integrally formed by Al-Mg alloy materials, as the connection portion (bent portion A) is a bent portion for the whole structure, compared with the frame 32, base 31, and other flat portions, the portion A tends to bear a larger stress load due to the stress concentration phenomenon under a great external force, and thus becoming the most fragile portion of the whole structure. Moreover, through a practical stretching test, when the external force applied to the frame 32 is continuously increased, the connection portion (bent portion A) between the frame 32 and the base 31 may be deformed or damaged, and as shown in FIG. 5, the connection portion is damaged and a crack A′ is formed, such that the frame 32 is bent and deformed towards the external side of the base 31 upon being pulled by the external force. Accordingly, the stopping portion 322 is driven to generate a displacement relative to the base 31, such that the sensor 33 is not disposed closely adjacent to the frame 32 any more, and meanwhile, the stopping portion 322 is released from the toggle switch 331. As such, the toggle switch 331 is moved from a normal position to a trigger position, which drives the sensor 33 to generate a trigger signal.

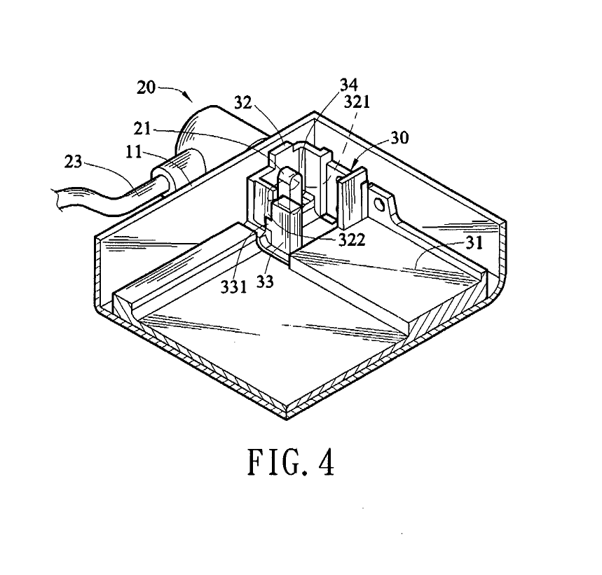

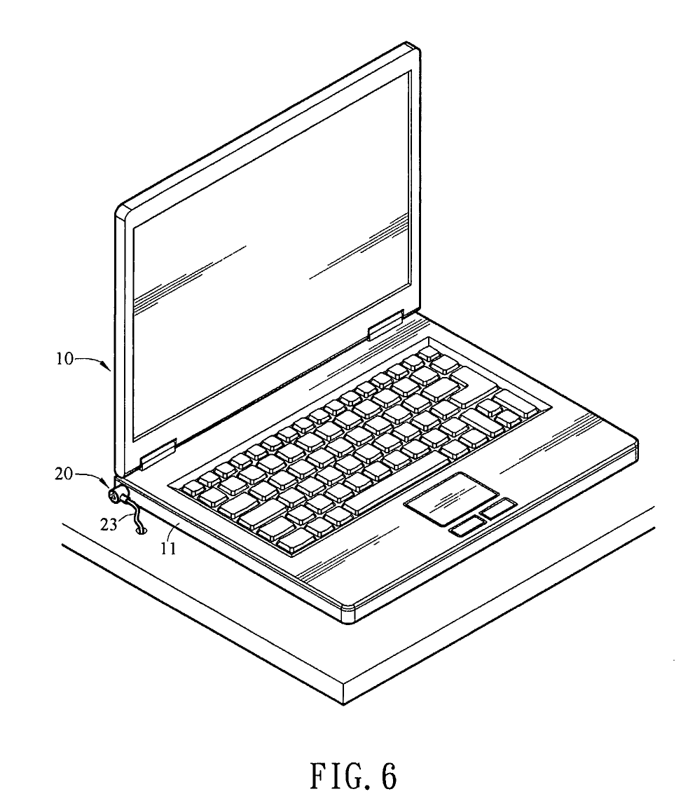

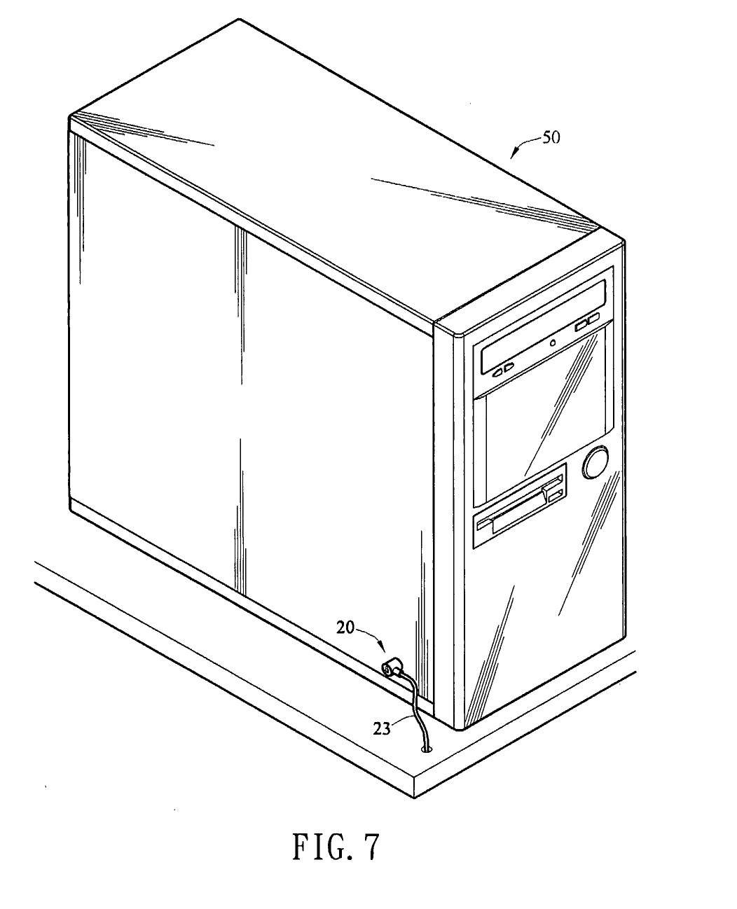

Referring to FIG. 6 and FIG. 7, the anti-theft lock structure 30 of the present invention not only can be mounted on the portable electronic device 10, which is not limited herein, but also applied to a desktop computer 50 for the same purpose, or applied to various electronic products with a high unit price. The trigger signal generated by the sensor 33 in the anti-theft lock structure 30 (as shown in FIG. 4) can actuate another protection mechanism to protect various anti-theft objects. For example, when it is applied to display items in an exhibition hall, the trigger signal generated by the sensor 33 is transmitted to a sound alarm device, such that the alarm device is actuated when the displayed item is pulled by force, and thereby achieving the anti-theft efficacy. In another aspect, if it is applied to a personal or enterprise electronic device, taking a notebook computer as an example, the trigger signal generated by the sensor 33 is linked to a hard disk anti-theft lock. If the notebook computer is stolen by a person, the hard disk anti-theft lock is actuated to prevent the hard disk from being booted and used, so as to ensure that the important data in the electronic device may not be disclosed out.

In view of the above, by disposing the anti-theft lock structure 30 of the present invention in the portable electronic device 10, when the first anti-theft measure is damaged, the second anti-theft mechanism is further actuated, so as to apparently alleviate the risk of being stolen and lost through the dual anti-theft mechanism, and meanwhile to prevent the confidential data in the stolen item from being disclosed out after being stolen unfortunately. Thus, the loss of the individual and the enterprise caused by the items being stolen or getting lost can be effectively reduced, so as to eliminate the defects of the anti-theft performance of the conventional locking mechanism.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. An anti-theft lock structure, applicable for a lock tongue of a lock to be inserted in, comprising:
a base;
a frame, fixed to one side of the base, having a lock hole and a stopping portion, wherein the lock tongue is inserted into the frame through the lock hole; and ‘a sensor, fixed in the base and connected to one side of the stopping portion of the frame, for detecting a displacement of the stopping portion relative to the base when the frame is deformed under an external force, so as to generate a trigger signal.

2. The anti-theft lock structure as claimed in claim 1, wherein strength of a structural stress of the frame is greater than that of a connection portion between the frame and the base.

3. The anti-theft lock structure as claimed in claim 1, wherein the sensor further comprises a toggle switch closely attached to the stopping portion; the toggle switch is normally pressed by the stopping portion to be maintained at a normal position, and once the frame is deformed, the toggle switch is moved to a trigger position, so as to drive the sensor to generate a trigger signal.

4. A notebook computer having an anti-theft lock structure, comprising:
a base, for bearing electronic elements in the notebook computer;
a frame, fixed to one side of the base, having a lock hole and a stopping portion, wherein the lock hole is engaged with the lock tongue of the lock, and the lock tongue is inserted into the frame through the lock hole; and
a sensor, fixed in the base and closely connected to one side of the stopping portion of the frame, for detecting a displacement of the stopping portion relative to the base when the frame is deformed under an external force, so as to generate a trigger signal;
wherein strength of a structural stress of the frame is greater than that of a connection portion between the frame and the base.

5. The notebook computer having the anti-theft lock structure as claimed in claim 4,
wherein the sensor further comprises a toggle switch, closely attached to a lower side of the stopping portion; the toggle switch is maintained at a normal position when the frame is deformed, or once the frame is deformed, the toggle switch is moved to a trigger position, so as to drive the sensor to generate a trigger signal. 10/11
